(19) United States
(12) Patent Application Publication
(10) Pub. No.: US 2022/0007913 A1
(43) Pub. Date: Jan. 13, 2022

(54) SELF-MOVING EQUIPMENT, CONTROL METHOD, CONTROL DEVICE AND STORAGE MEDIUM THEREOF

(71) Applicant: Dreame Innovation Technology (Suzhou) Co., Ltd., Suzhou City (CN)

(72) Inventors: Shunchang YU, Suzhou City (CN); Zhen WANG, Suzhou City (CN); Shenghao TANG, Suzhou City (CN)

(73) Assignee: Dreame Innovation Technology (Suzhou) Co., Ltd., Suzhou City (CN)

(21) Appl. No.: 17/371,601

(22) Filed: Jul. 9, 2021

(30) Foreign Application Priority Data
Jul. 13, 2020 (CN) 202010666135.7

(51) Int. Cl. A47L 11/40; G06K 9/00; G05D 1/02; G06N 3/08

(52) U.S. Cl. CPC A47L 11/4011; G06K 9/00664; G05D 1/0246; G05D 1/0221; G05D 1/0219; G05D 2201/0203; G06N 3/08; A47L 2201/022; A47L 2201/04; A47L 2201/06; G05D 1/0225

(57) ABSTRACT

The present disclosure relates to a self-moving equipment, a control method, a control device and a storage medium of the self-moving equipment. The control method includes: obtaining the environment images identified by the image identification component; obtaining the image identification model by which computing resources occupied in operation are lower than the maximum computing resources provided by the self-moving equipment; obtaining an object identification result through controlling the environment images inputted into the image identification model so as to indicate the category of the target objects in the environment images. By using an image identification model that consumes less computing resources to identify target objects in the environment images, the hardware requirements of the object identification method on self-moving equipment can be reduced, and the application range of the object identification method can be expanded.

### CROSS-REFERENCE TO RELATED APPLICATION

This patent application claims priority of a Chinese Patent Application No. 202010666135.7, filed on Jul. 13, 2020 and titled “SELF-MOVING EQUIPMENT, CONTROL METHOD, CONTROL DEVICE AND STORAGE MEDIUM THEREOF”, the entire content of which is incorporated herein by reference.

### TECHNICAL FIELD

The present disclosure relates to a self-moving equipment, a control method, a control device and a storage medium of the self-moving equipment, which belongs to a technical field of computer technology.

### BACKGROUND

With the development of artificial intelligence and the robotics industry, smart home appliances such as sweeping robots have gradually become popular.

A common sweeping robot identifies environment pictures through a camera component fixed above a body of the sweeping robot. The sweeping robot adopts image identification algorithms to identify objects in the identified pictures. In order to ensure the accuracy of image identification, the image identification algorithms are usually obtained by training based on neural network models.

However, the existing image identification algorithms require a combination of a graphics processor (Graphics Processing Unit, GPU) and a neural network processor (Neural Processing Unit, NPU) to implement, therefore hardware requirements of the sweeping robots are relatively high.

### SUMMARY

The present disclosure provides a self-moving equipment, a control method, a control device and a storage medium of the self-moving equipment. The present disclosure is capable of solving the problem that the existing image identification algorithms have high requirements on the hardware of the sweeping robots, which results in a limited application range of the object identification function of the sweeping robots.

The present disclosure provides following technical solutions:

A first aspect of the present disclosure provides a control method of a self-moving equipment, wherein the self-moving equipment includes an image identification component, the control method including:

obtaining an environment image identified by the image identification component;

obtaining an image identification model, computing resources occupied by the image identification model during operation being lower than maximum computing resources provided by the self-moving equipment; and

controlling the environment image inputted into the image identification model so as to obtain an object identification result, the object identification result being used to indicate categories of target objects.

A second aspect of the present disclosure provides a control device of a self-moving equipment, wherein the self-moving equipment includes an image identification component, and the control device including:

an image acquisition module, the image acquisition module being adapted to acquire an environment image identified by the image identification component during movement of the self-moving equipment;

a model acquisition module, the model acquisition module being adapted to acquire an image identification model, computing resources occupied by the image identification model during operation being lower than maximum computing resources provided by the self-moving equipment; and

a device control module, the device control module being adapted to control inputting the environment image into the image identification model so as to obtain an object identification result, the object identification result being used to indicate categories of target objects.

A third aspect of the present disclosure provides a control device of a self-moving equipment, wherein the control device includes a processor and a memory, a program is stored in the memory, the program is loaded by the processor and executed to realize the above control method of the self-moving equipment.

A fourth aspect of the present disclosure provides a computer-readable storage medium, wherein a program is stored in the computer-readable storage medium, and wherein when the program is executed by the processor, the program is used to implement the above control method of the self-moving equipment.

A fifth aspect of the present disclosure provides a self-moving equipment, including:

a movement component for driving movement of the self-moving equipment;

a movement driving component for driving movement of the movement component;

an image identification component installed on the self-moving equipment and adapted to acquire an environment image in a moving direction of the self-moving equipment; and

a control component being communicatively connected with the movement driving component and the image identification component, the control component being communicatively connected with a memory, a program being stored in the memory, the program being loaded by the control component and executed to realize the above control method of the self-moving equipment.

Beneficial effects of the present disclosure include: by obtaining the environment images identified by the image identification component; by obtaining the image identification model by which computing resources occupied in operation are lower than the maximum computing resources provided by the self-moving equipment; by obtaining an object identification result through controlling the environment images inputted into the image identification model so as to indicate the category of the target objects in the environment images, the present disclosure can solve the problem that the existing image identification algorithms have high requirements on the hardware of the sweeping robots, which results in a limited application range of the object identification function of the sweeping robots. By using an image identification model that consumes less computing resources to identify target objects in the environment images, the hardware requirements of the object identification method on self-moving equipment can be reduced, and the application range of the object identification method can be expanded.

The above description is only an overview of the technical solutions of the present disclosure. In order to be able to understand the technical means of the present disclosure more clearly and implement them in accordance with the content of the specification, preferred embodiments of the present disclosure are described in detail below in conjunction with the accompanying drawings.

### BRIEF DESCRIPTION OF DRAWINGS

FIG. 1 is a schematic structural diagram of a self-moving equipment in accordance with an embodiment of the present disclosure;

FIG. 2 is a flowchart of a control method of the self-moving equipment in accordance with an embodiment of the present disclosure;

FIG. 3 is a flowchart of an execution work strategy in accordance with an embodiment of the present disclosure;

FIG. 4 is a schematic diagram of an execution work strategy in accordance with an embodiment of the present disclosure;

FIG. 5 is a flowchart of an execution work strategy in accordance with another embodiment of the present disclosure;

FIG. 6 is a schematic diagram of an execution work strategy in accordance with another embodiment of the present disclosure;

FIG. 7 is a block diagram of a control device of a self-moving equipment in accordance with an embodiment of the present disclosure; and

FIG. 8 is a block diagram of a control device of a self-moving equipment in accordance with an embodiment of the present disclosure.

### DETAILED DESCRIPTION

The specific embodiments of the present disclosure will be described in further detail below in conjunction with the accompanying drawings. The following embodiments are used to illustrate the present disclosure, but are not used to limit the scope of the present disclosure.

First of all, the following introduces several terms involved in the present disclosure.

Model compression: It refers to reducing the parameter redundancy in the trained network model, thereby reducing the storage occupation, communication bandwidth and computational complexity of the network model.

Model compression includes but is not limited to model tailoring, model quantization and/or low-rank decomposition.

Model tailoring: It refers to the search process of the optimal network structure. The process of model tailoring includes following steps: 1. training the network model; 2. tailoring unimportant weights or channels; 3. fine-tuning or retraining the tailored network. Among them, the second step usually uses iterative layer-by-layer tailoring, fast fine-tuning, or weight reconstruction to maintain accuracy.

Quantization: A quantization model is a general term for model acceleration methods.

It is a process of representing a limited range (such as 32-bit) floating-point data in a data type with fewer digits, so as to achieve the goals of reducing model size, reducing model memory consumption, and accelerating model inference speed.

Low-rank decomposition: It refers to decomposing the weight matrix of the network model into multiple small matrices. The calculation amount of the small matrix is smaller than that of the original matrix, thereby reducing the amount of model calculations and reducing the memory occupied by the model.

YOLO model: It is one of the basic network models. It is a neural network model that can achieve target positioning and identification through a convolutional neural network (Convolutional Neural Networks, CNN). YOLO models include YOLO, YOLO v2 and YOLO v3. Among them, YOLO v3 is another target detection algorithm of the YOLO series after YOLO and YOLO v2, and it is an improvement based on YOLO v2. YOLO v3-tiny is a simplified version of YOLO v3, in which some feature layers are removed on the basis of YOLO v3, so as to achieve the effect of reducing the amount of model calculations and faster calculations.

MobileNet model: It is a network model in which the basic unit is a depthwise separable convolution. The depthwise separable convolution can be decomposed into depthwise convolution (Depthwise, DW) and pointwise convolution (Pointwise, PW). DW is different from the standard convolution. For the standard convolution, the convolution kernel is used on all input channels, while DW uses a different convolution kernel for each input channel. In other words, one convolution kernel corresponds to one input channel. The PW is an ordinary convolution, but it uses a 1×1 convolution kernel. For the depthwise separable convolution, it firstly uses DW to convolve different input channels separately, and then uses PW to combine the above outputs. In this way, in fact, the overall calculation result is approximately the same as the calculation result of a standard convolution process, but it will greatly reduce the amount of calculation and the amount of model parameters.

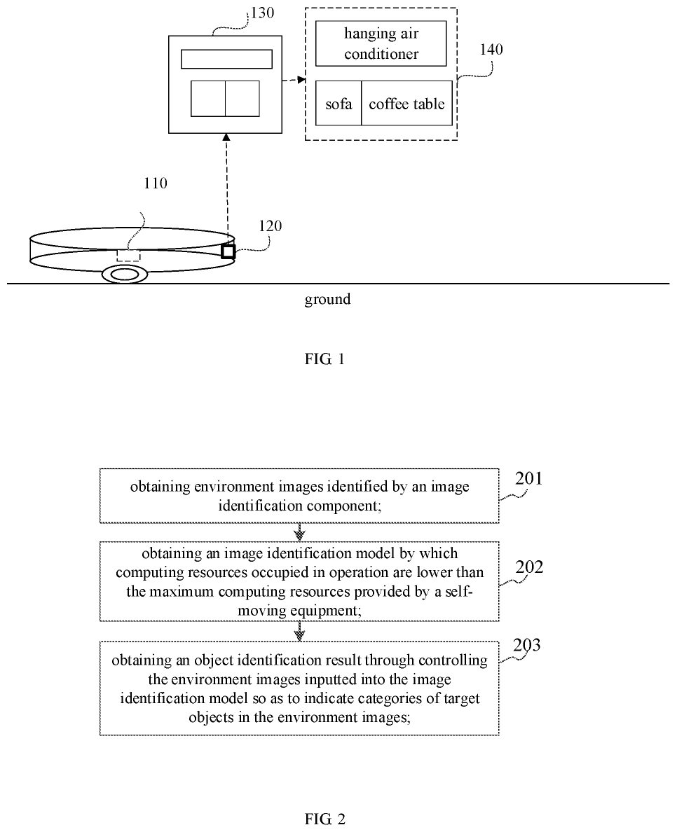

FIG. 1 is a schematic structural diagram of a self-moving equipment in accordance with an embodiment of the present disclosure. As shown in FIG. 1, the device at least includes a control component 110 and an image identification component 120 communicatively connected with the control component 110.

The image identification component 120 is used to identify environment images 130 during the movement of the self-moving equipment, and send the environment images 130 to the control component 110. Optionally, the image identification component 120 may be implemented as a camera, a video camera, etc. The present embodiment does not limit the implementation manner of the image identification component 120.

Optionally, field of view of the image identification component 120 is 120° in a horizontal direction and 60° in a vertical direction. Of course, the field of view can also be other values. The present embodiment does not limit the values of the field of view of the image identification component 120. The field of view of the image identification component 120 can ensure that the environment image 130 in the moving direction of the self-moving equipment can be captured.

In addition, the number of image identification component 120 may be one or more, which is not limited by the present disclosure.

The control component 110 is used to control the self-moving equipment, for example to control the start and stop of the self-moving equipment, and to control the start and stop of various components (such as the image identification component 120) in the self-moving equipment.

In this embodiment, the control component 110 is communicatively connected with a memory. A program is stored in the memory, and the program is loaded by the control component 110 and executed to at least implement the following steps: obtaining the environment image 130 identified by the image identification component 120; obtaining an image identification model; controlling inputting the environment image 130 into the image identification model so as to obtain an object identification result 140. The object identification result 140 is used to indicate categories of target objects in the environment image 130. In other words, the program is loaded and executed by the control component 110 to implement a control method of the self-moving equipment provided in the present disclosure.

In one example, when the target object is included in the environment image, the object identification result 140 is the type of the target object; when the target object is not included in the environment image, the object identification result 140 is empty. Or, when the target object is included in the environment image, the object identification result 140 is an indication that the target object is included (for example, the target object is indicated by “1”) and the type of the target object; when the target object is not included in the environment image, the object identification result 140 is an indication that the target object is not included (for example, “0” indicates that the target object is not included).

Among them, computing resources occupied by the image identification model during operation are lower than maximum computing resources provided by the self-moving equipment

Optionally, the object identification result 140 may also include, but is not limited to, information such as the position and size of the image of the target object in the environment image 130.

Optionally, the target object is an object located in a working area of the self-moving equipment. For example, when the working area of the self-moving equipment is a room, the target object can be a bed, a table, a chair, a person, etc., in the room. When the working area of the self-moving equipment is a logistics warehouse, the target object can be a box or a person etc., in the warehouse. This embodiment does not limit the type of the target object.

Optionally, the image identification model is a network model in which the number of model layers is less than a first value; and/or the number of nodes in each layer is less than a second value. Wherein, the first value and the second value are both small integers, so as to ensure that the image identification model consumes less computing resources during operation.

It should be supplemented that, in this embodiment, the self-moving equipment may also include other components, such as a movement component (such as a wheel) used to drive the self-moving equipment to move, and a movement driving component (such as a motor) and so on. Wherein, the movement driving component is communicatively connected with the control component 110, and the movement driving component runs and drives the movement component to move under the control of the control component 110, thereby realizing the overall movement of the self-moving equipment. In this embodiment, the components included in the self-moving equipment are not listed one by one here.

In addition, the self-moving equipment may be a sweeping robot, an automatic lawn mower, or other devices with automatic driving function, and the present disclosure does not limit the type of the self-moving equipment.

In this embodiment, by using an image identification model that consumes less computing resources to identify the target object in the environment image 130, the hardware requirements of the object identification method on the self-moving equipment can be reduced, and the application range of the object identification method can be expanded.

The following describes in detail the control method of the self-moving equipment provided in the present disclosure.

FIG. 2 is a flowchart of a control method of the self-moving equipment. In FIG. 2, the control method of the self-moving equipment is used in the self-moving equipment shown in FIG. 1, and the execution subject of each step is the control component 110 as an example for description. Referring to FIG. 2, the control method includes at least the following steps:

Step 201: obtaining an environment image identified by the image identification component.

Optionally, the image identification component is used to capture video data, and at this time, the environment image may be one frame of image data in the video data; or, the image identification component is used to capture a single image data, and at this time, the environment image is a single piece of image data sent by the image identification component.

Step 202: obtaining an image identification model. The computing resources occupied by the image identification model during operation are lower than the maximum computing resources provided by the self-moving equipment.

In this embodiment, by using the image identification model with computing resources lower than the maximum computing resources provided by the self-moving equipment, the hardware requirements of the image identification model on the self-moving equipment can be reduced, and the application range of the object identification method can be expanded.

In one example, the pre-trained image identification model is read by the self-moving equipment. At this time, the image identification model is obtained by training a small network detection model. Training the small network detection model includes: obtaining the small network detection model; obtaining training data; inputting the training image into the small network detection model to obtain a model result; and training the small network detection model, based on the difference between the model result and the identification result corresponding to the training image, so as to obtain the image identification model.

Wherein, the training data includes the training images of each object in the working area of the self-moving equipment and the identification result of each training image.

In this embodiment, the small network model refers to a network model in which the number of model layers is less than the first value; and/or, the number of nodes in each layer is less than the second value. Wherein, the first value and the second value are both smaller integers. For example, the small network detection model is a miniature YOLO model a MobileNet model. Of course, the small network detection model may also be other models, which will not be listed one by one here in this embodiment.

Optionally, in order to further compress the computing resources occupied during the operation of the image identification model, after the small network detection model is trained to obtain the image identification model, the self-moving equipment can also perform model compression processing on the image identification model so as to obtain the image identification model used to identify the object.

Optionally, the model compression processing includes, but is not limited to: model tailoring, model quantization and/or low-rank decomposition.

Optionally, after the model compression is completed, the self-moving equipment can use the training data again to train the image identification model, so as to improve the identification accuracy of the image identification model.

Step 203: controlling the environment image inputted into the image identification model to obtain the object identification result, and the object identification result is used to indicate the category of the target object.

Optionally, the object identification result also includes, but is not limited to, information such as the position and/or size of the image of the target object in the environment image.

In summary, according to the control method of the self-moving equipment provided in this embodiment, by obtaining the environment images identified by the image identification component; by obtaining the image identification model by which computing resources occupied in operation are lower than the maximum computing resources provided by the self-moving equipment; by obtaining the object identification result through controlling the environment images inputted into the image identification model so as to indicate the category of the target objects in the environment images, the present disclosure can solve the problem that the existing image identification algorithms have high requirements on the hardware of the sweeping robots, which results in a limited application range of the object identification function of the sweeping robots. By using an image identification model that consumes less computing resources to identify target objects in the environment images, the hardware requirements of the object identification method on self-moving equipment can be reduced, and the application range of the object identification method can be expanded.

In addition, the image identification model is obtained by training and learning using the small network model, and the combination of a graphics processor (Graphics Processing Unit, GPU) and an embedded neural network processor (Neural-network Processing Units, NPU) is not required to realize the object identification process. Therefore, the requirements for the device hardware of the object identification method can be reduced.

In addition, performing model compression processing on the image identification model to obtain the image identification model used to identify the object can further reduce the computing resources occupied by the image identification model during operation, increase the identification speed, and expand the application range of the object identification method.

Optionally, based on the foregoing embodiment, in the present disclosure, after the object identification result is obtained by the self-moving equipment, the self-moving equipment is further controlled to move based on the object identification result to complete corresponding tasks. These tasks include but are not limited to: realizing the task of avoiding obstacles for certain objects, such as avoiding obstacles for chairs, pet feces, etc.; the task of positioning certain objects, such as positioning doors and windows, charging components, etc.; the task of monitoring and following people; the task of cleaning specific items, such as cleaning liquid; and/or, the task of automatic refilling. Below, the tasks executed corresponding to different object identification results are introduced.

Optionally, a liquid cleaning component is installed on the self-moving equipment. At this time, after the step 203, controlling the self-moving equipment to move so as to complete the corresponding task based on the object identification result includes: when the object identification result indicates that the environment image contains a liquid image, controlling the self-moving equipment to move to an area to be cleaned corresponding to the liquid image; and cleaning the liquid in the area by using the liquid cleaning component.

In one example, the liquid cleaning component includes a water-absorbing mop installed on the periphery of a wheel body of the self-moving equipment. When there is a liquid image in the environment image, the self-moving equipment is controlled to move to the area to be cleaned corresponding to the liquid image, so that the wheel of the self-moving equipment passes through the area to be cleaned. As a result, the water-absorbing mop absorbs the liquid on the ground. The self-moving equipment also includes a cleaning tank and a reservoir. The cleaning tank is located under the wheel body. A water pump sucks the water in the reservoir, sprays it from a nozzle to the wheel body through a pipe, and flushes the dirt on the water-absorbing mop to the cleaning tank. A pressure roller is provided on the wheel body to wring out the water-absorbing mop.

Of course, the above-mentioned liquid cleaning components are only illustrative. In actual implementation, the liquid cleaning component may also be realized in other ways, which will not be listed one by one here in the embodiment.

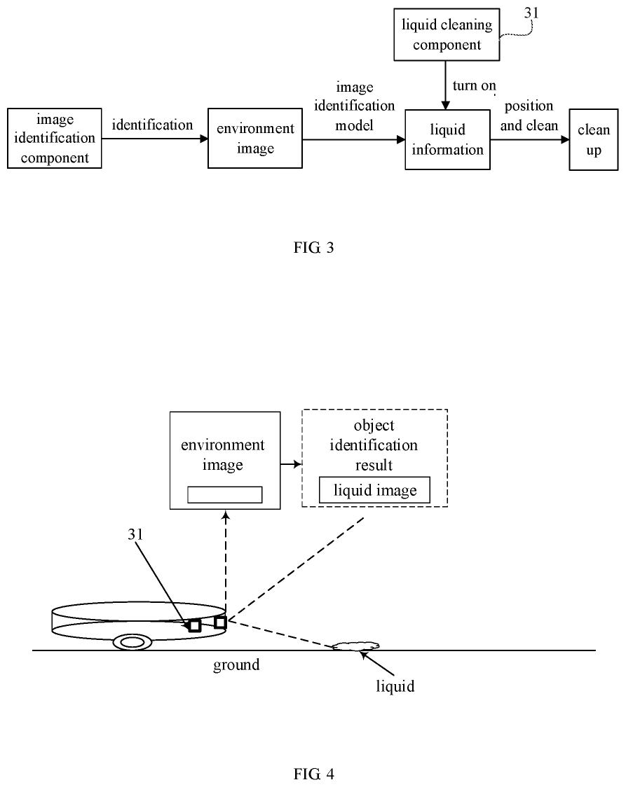

In order to have a clearer understanding of the manner of executing the corresponding work strategy based on the object identification result, refer to the schematic diagrams of executing the cleaning liquid work strategy shown in FIGS. 3 and 4. According to FIGS. 3 and 4, it can be seen that after the self-moving equipment captures the environment image, the image identification model is used to obtain the object identification result of the environment image. When the object identification result is that the current environment includes the liquid, the liquid cleaning component 31 is used to clean the liquid.

Optionally, in this embodiment, the self-moving equipment may be a sweeping robot. At this time, the self-moving equipment has the function of removing all dry and wet garbage.

In this embodiment, by activating the liquid cleaning component when there is a liquid image in the environment image, the self-moving equipment can avoid the problem that the self-moving equipment circumvents the liquid and the cleaning task cannot be completed; and the cleaning effect of the self-moving equipment can be improved. At the same time, liquid can be prevented from entering the self-moving equipment, causing circuit damage, and the risk of damage to the self-moving equipment can be reduced.

Optionally, based on the above embodiment, a power supply component is installed in the self-moving equipment. Controlling the self-moving equipment to move so as to complete the corresponding task based on the object identification result, includes determining the actual position of the charging component by the self-moving equipment according to the image position of the charging component, when the remaining power of the power supply component is less than or equal to the power threshold, and the environment image includes the image of the charging component; and controlling the self-moving equipment to move to the charging component.

Since the image of the charging component is identified by the self-moving equipment, the direction of the charging component relative to the self-moving equipment can be determined according to the position of the image in the environment image. Therefore, the self-moving equipment can move to the charging component according to the roughly determined direction.

Optionally, in order to improve the accuracy of the movement of the self-moving equipment to the charging component, a positioning sensor is also installed on the self-moving equipment. The positioning sensor is used to position the location of the charging port on the charging component. At this time, when the self-moving equipment is controlling the movement of the self-moving equipment to the charging component, the positioning sensor is controlled to position the location of the charging component to obtain the positioning result; the self-moving equipment is controlled to move according to the positioning result to realize the mating of the self-moving equipment with the charging port.

In one example, the positioning sensor is a laser sensor. At this time, the charging port of the charging component emits laser signals at different angles. The positioning sensor determines the position of the charging port based on the angle difference of the laser signals which are received.

Of course, the positioning sensor can be other types of sensors, and this embodiment does not limit the type of the positioning sensor.

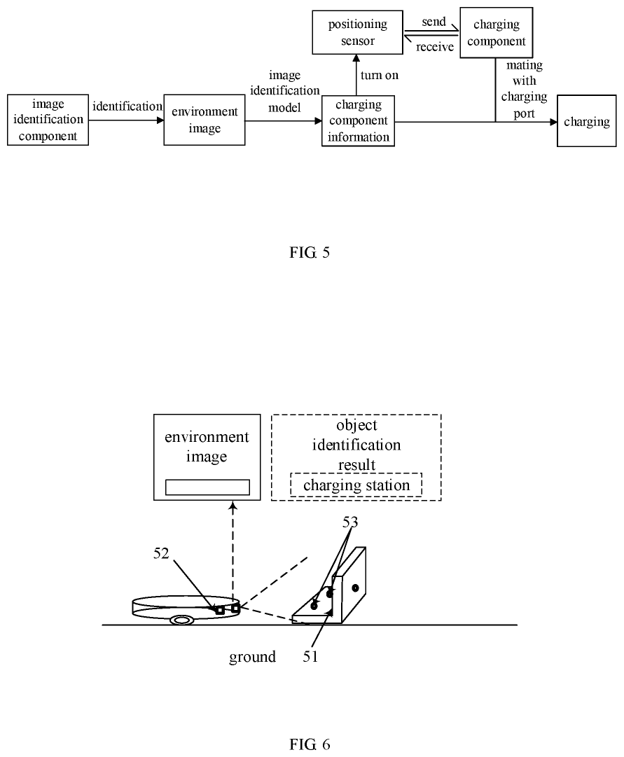

In order to have a clearer understanding the manner of executing the corresponding work strategy based on the object identification result, refer to the schematic diagrams of executing the cleaning liquid work strategy shown in FIGS. 5 and 6. According to FIGS. 5 and 6, it can be seen that after the self-moving equipment captures the environment image, the image identification model is used to obtain the object identification result of the environment image. When the object identification result is that the current environment includes the charging component 51, the positioning sensor 52 is used to position the location of the charging port 53 on the charging component 51; and the self-moving equipment moves to the charging port 53 so that the self-moving equipment is electrically connected to the charging component 51 through the charging port to realize charging.

In this embodiment, the charging component is identified through the image identification model and moved to the vicinity of the charging component, so that the self-moving equipment can automatically return to the charging component for charging, thereby improving the intelligence of the self-moving equipment.

In addition, determining the position of the charging port on the charging component through the positioning sensor can improve the accuracy when the self-moving equipment automatically returns to the charging component, thereby improving the efficiency of automatic charging.

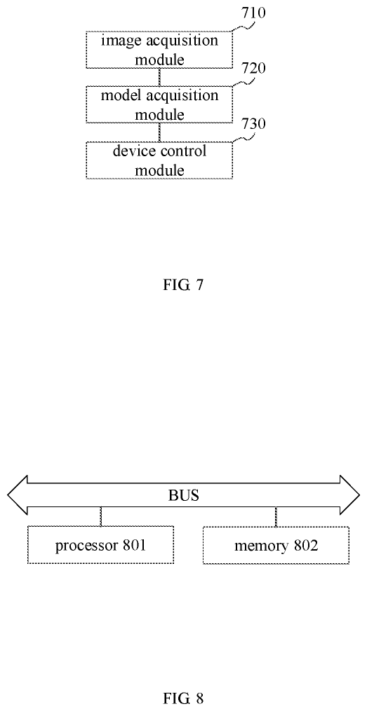

FIG. 7 is a block diagram of a control device for the self-moving equipment provided by an embodiment of the present disclosure. In this embodiment, the application of the device in the self-moving equipment shown in FIG. 1 is taken as an example for description. The control device includes at least the following modules: an image acquisition module 710, a model acquisition module 720 and a device control module 730.

The image acquisition module 710 is adapted to acquire the environment image identified by the image identification component during the movement of the self-moving equipment.

The model acquisition module 720 is adapted to acquire the image identification model. The computing resources occupied by the image identification model during operation are lower than the maximum computing resources provided by the self-moving equipment.

The device control module 730 is adapted to control inputting the environment image into the image identification model to obtain the object identification result. The object identification result is used to indicate the category of the target object.

For related details, refer to the above method embodiment.

It should be noted that, when the control device of the self-moving equipment provided in the above embodiment performs the control of the self-moving equipment, only the division of the above-mentioned functional modules is used for illustration. In practical applications, the above-mentioned functions can be allocated by different functional modules as required. That is, the internal structure of the control device of the self-moving equipment is divided into different functional modules in order to complete all or part of the functions described above. In addition, the control device of the self-moving equipment provided in the above-mentioned embodiment belongs to the same concept as the embodiment of the control method of the self-moving equipment. For the specific implementation process, please refer to the method embodiment, which will not be repeated here.

FIG. 8 is a block diagram of a control device of a self-moving equipment provided by an embodiment of the present disclosure. The control device may be a self-moving equipment as shown in FIG. 1. Of course, the control device can also be other devices that are installed on the self-moving equipment and independent of the self-moving equipment. The control device at least includes a processor 801 and a memory 802.

The processor 801 may include one or more processing cores, such as a 4-core processor, an 8-core processor, and so on. The processor 801 may adopt at least one hardware form among DSP (Digital Signal Processing), FPGA (Field-Programmable Gate Array), and PLA (Programmable Logic Array). The processor 801 may also include a main processor and a coprocessor. The main processor is a processor used to process data in an awake state, and is also called a CPU (Central Processing Unit). The coprocessor is a low-power processor used to process data in a standby state. In some embodiments, the processor 801 may further include an AI (Artificial Intelligence) processor. The AI processor is used to process computing operations related to machine learning.

The memory 802 may include one or more computer-readable storage media. The computer-readable storage medium may be non-transitory. The memory 802 may also include high-speed random access memory and non-volatile memory, such as one or more magnetic disk storage devices and flash memory storage devices. In some embodiments, a non-transitory computer-readable storage medium in the memory 802 is used to store at least one instruction. The at least one instruction is used to be executed by the processor 801 to implement the control method of the self-moving equipment provided in the embodiment of the present disclosure.

In some embodiments, optionally, the control device of the self-moving equipment may further include a peripheral device port and at least one peripheral device. The processor 801, the memory 802 and the peripheral device port may be connected through a BUS or a signal line. Each peripheral device can be connected to the peripheral device port through a BUS, a signal line or a circuit board. Illustratively, the peripheral devices include, but are not limited to, radio frequency circuits, touch screens, audio circuits and power supplies etc.

Of course, the control device of the self-moving equipment may also include fewer or more components, which is not limited in this embodiment.

Optionally, the present disclosure also provides a computer-readable storage medium. The computer-readable storage medium stores a program. The program is loaded and executed by the processor to implement the control method of the self-moving equipment in the above method embodiment.

Optionally, the present disclosure also provides a computer product. The computer product includes a computer-readable storage medium. The computer-readable storage medium stores a program. The program is loaded and executed by the processor to implement the control method of the mobile device in the above method embodiment.

In the case of no conflict, the technical features of the above-mentioned embodiments can be combined arbitrarily. In order to make the description concise, all possible combinations of the various technical features in the above embodiments are not described. However, as long as there is no contradiction in the combination of these technical features, it should be regarded as the scope described in this specification.

The above embodiments only express several implementation manners of the present disclosure, and the description is relatively specific and detailed, but it should not be understood as a limitation on the scope of the present disclosure. It should be pointed out that for those of ordinary skill in the art, without departing from the concept of the present disclosure, several modifications and improvements can be made, and these all fall within the protection scope of the present disclosure. Therefore, the protection scope of the present disclosure should be subject to the appended claims.

What is claimed is:

1. A control method of a self-moving equipment, wherein the self-moving equipment comprises an image identification component, the control method comprising:
obtaining an environment image identified by the image identification component;
obtaining an image identification model, computing resources occupied by the image identification model during operation being lower than maximum computing resources provided by the self-moving equipment; and
controlling the environment image inputted into the image identification model so as to obtain an object identification result, the object identification result being used to indicate categories of target objects.

2. The control method according to claim 1, wherein the image identification component is adapted to acquire the environment image during movement of the self-moving equipment.

3. The control method according to claim 2, wherein the image identification component is adapted to acquire the environment image in a moving direction of the self-moving equipment.

4. The control method according to claim 3, wherein field of view of the image identification component is 120° in a horizontal direction and 60° in a vertical direction.

5. The control method according to claim 1, wherein the image identification model is obtained by training a small network detection model.

6. The control method according to claim 1, wherein before obtaining the image identification model, the control method further comprises:
obtaining a small network detection model;
obtaining training data, the training data comprising training images of each object in a working area of the self-moving equipment and an identification result of each training image;
inputting the training images into the small network detection model so as to obtain a model result; and
training the small network detection model based on a difference between the model result and the identification result corresponding to the training images so as to obtain the image identification model.

7. The control method according to claim 6, wherein after training the small network detection model based on the difference between the model result and the identification result corresponding to the training images so as to obtain the image identification model, the control method further comprises:
processing model compression on the image identification model to obtain the image identification model for object identification, the model compression including model tailoring, model quantization and/or low-rank decomposition.

8. The control method according to claim 7, wherein after the model compression is completed, the training data is used again to train the image identification model so as to obtain a finally used image identification model.

9. The control method according to claim 5, wherein the small network detection model is a miniature YOLO model or a MobileNet model.

10. The control method according to claim 1, wherein after controlling the environment image inputted into the image identification model so as to obtain the object identification result, the control method further comprises:
controlling the self-moving equipment to move so as to complete a corresponding task based on the object identification result.

11. The control method according to claim 10, wherein the self-moving equipment comprises a liquid cleaning component; and wherein controlling the self-moving equipment to move so as to complete the corresponding task based on the object identification result comprises:
when the object identification result indicates that the environment image contains a liquid image, controlling the self-moving equipment to move to an area to be cleaned corresponding to the liquid image; and
cleaning the liquid in the area by using the liquid cleaning component.

12. The control method according to claim 10, wherein the self-moving equipment comprises a power supply component, and the power supply component uses a charging component for charging; wherein controlling the self-moving equipment to move so as to complete the corresponding task based on the object identification result comprises:
controlling the self-moving equipment to move to the charging component, when remaining power of the power supply component is less than or equal to a power threshold, and the charging component is identified in the object identification result.

13. The control method according to claim 12, wherein before controlling the self-moving equipment to move to the charging component, the control method further comprises:
determining a direction of the charging component relative to the self-moving equipment according to a position of an image of the charging component in the environment image.

14. The control method according to claim 12, wherein the self-moving equipment comprises a positioning sensor, and the positioning sensor is used to position a location of the charging component; wherein after the self-moving equipment is controlled and moved to the charging component, the control method further comprises:
controlling the positioning sensor to position the location of the charging component so as to obtain a positioning result, in a process of moving to the charging component; and
controlling the self-moving equipment to move according to the positioning result, so as to realize a mating of the self-moving equipment with the charging component.

15. The control method according to claim 14, wherein controlling the positioning sensor to position the location of the charging component so as to obtain the positioning result, comprises: controlling the positioning sensor to position a location of a charging port on the charging component; and
controlling the self-moving equipment to move according to the positioning result, comprises: controlling the self-moving equipment to move to the charging port.

16. A control device of a self-moving equipment, wherein the self-moving equipment comprises an image identification component, and the control device comprising:
an image acquisition module, the image acquisition module being adapted to acquire an environment image identified by the image identification component during movement of the self-moving equipment;
a model acquisition module, the model acquisition module being adapted to acquire an image identification model, computing resources occupied by the image identification model during operation being lower than maximum computing resources provided by the self-moving equipment; and
a device control module, the device control module being adapted to control inputting the environment image into the image identification model so as to obtain an object identification result, the object identification result being used to indicate categories of target objects.

17. The control device according to claim 16, wherein the image identification component acquires the environment image in a moving direction of the self-moving equipment, field of view of the image identification component is 120° in a horizontal direction and 60° in a vertical direction;
the target objects comprises chairs, pet feces, doors, windows, charging components and/or liquids;
before obtaining the image identification model, the control device further comprises:
a module adapted to obtain a small network detection model, the small network detection model removing a feature layer;
a module adapted to obtain training data, the training data comprising training images of each object in a working area of the self-moving equipment and an identification result of each training image;
a module adapted to input the training images into the small network detection model so as to obtain a model result;
a module adapted to train the small network detection model based on a difference between the model result and the identification result corresponding to the training image so as to obtain the image identification model;
a module adapted to process model compression on the image identification model to obtain the image identification model for object identification, the model compression including model tailoring, model quantization and/or low-rank decomposition;
after the model compression is completed, the training data is used again to train the image identification model so as to obtain a finally used image identification model;
wherein the control device of the self-moving equipment further comprises:
a movement control module adapted to control the self-moving equipment to move so as to complete a corresponding task, based on the object identification result;
a power supply component being installed in the self-moving equipment, the power supply component using a charging component for charging; the movement control module being specifically used to determine an actual position of the charging component according to an image position of the charging component, when remaining power of the power supply component is less than or equal to a power threshold, and the environment image includes an image of the charging component;
wherein the self-moving equipment comprises a positioning sensor, and the positioning sensor is used to position a location of a charging port on the charging component; and
wherein the movement control module is further used to control the positioning sensor to position the location of the charging component so as to obtain a positioning result, in a process of moving to the charging component; and control the self-moving equipment to move according to the positioning result, so as to realize a mating of the self-moving equipment with the charging port.

18. A control device of a self-moving equipment, wherein the control device comprises a processor and a memory, a program is stored in the memory, the program is loaded by the processor and executed to realize a control method of the self-moving equipment, the self-moving equipment comprises an image identification component, the control method comprising:
obtaining an environment image identified by the image identification component;
obtaining an image identification model, computing resources occupied by the image identification model during operation being lower than maximum computing resources provided by the self-moving equipment; and
controlling the environment image inputted into the image identification model so as to obtain an object identification result, the object identification result being used to indicate categories of target objects.

19. A computer-readable storage medium, wherein a program is stored in the computer-readable storage medium, and wherein when the program is executed by the processor, the program is used to implement a control method of a self-moving equipment, the self-moving equipment comprises an image identification component, the control method comprising:
obtaining an environment image identified by the image identification component;
obtaining an image identification model, computing resources occupied by the image identification model during operation being lower than maximum computing resources provided by the self-moving equipment; and
controlling the environment image inputted into the image identification model so as to obtain an object identification result, the object identification result being used to indicate categories of target objects.

20. A self-moving equipment, comprising:
a movement component for driving movement of the self-moving equipment;
a movement driving component for driving movement of the movement component;
an image identification component installed on the self-moving equipment and adapted to acquire an environment image in a moving direction of the self-moving equipment; and
a control component being communicatively connected with the movement driving component and the image identification component, the control component being communicatively connected with a memory, a program being stored in the memory, the program being loaded by the control component and executed to realize a control method of the self-moving equipment, the control method comprising:
obtaining an environment image identified by the image identification component;
obtaining an image identification model, computing resources occupied by the image identification model during operation being lower than maximum computing resources provided by the self-moving equipment; and
controlling the environment image inputted into the image identification model so as to obtain an object identification result, the object identification result being used to indicate categories of target objects.
